(19) United States
(12) Patent Application Publication
(10) Pub. No.: US 2018/0373184 A1
(43) Pub. Date: Dec. 27, 2018

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Yohei DOI, Mishima Shizuoka (JP)

(21) Appl. No.: 15/928,186

(22) Filed: Mar. 22, 2018

(30) Foreign Application Priority Data
Jun. 26, 2017 (JP) 2017-124622

(51) Int. Cl. G03G 15/20

(52) U.S. Cl. CPC G03G 15/2039; G03G 2215/00063; G03G 15/65; G03G 15/5025

(57) ABSTRACT

An image forming apparatus comprises a reading section configured to read a first image on a sheet, an image forming section configured to forma second image on the sheet, a fixing section configured to heat the sheet to fix the second image on the sheet, and a processor. The processor is configured to determine a color of the read first image, select a decolorable toner based on the determined color, and set a target temperature of the fixing section to a temperature that is below a decoloring temperature of the decolorable toner, and above both a decoloring temperature of a decolorable toner having the determined color and a fixing temperature for the decolorable toner.

### CROSS-REFERENCE TO RELATED APPLICATION

This application is based upon and claims the benefit of priority from Japanese Patent Application No. 2017-124622, filed Jun. 26, 2017, the entire contents of which are incorporated herein by reference.

### FIELD

Embodiments described herein relate generally to an image forming apparatus and an image forming method.

### BACKGROUND

Conventionally, an image forming apparatus, which forms an image on a sheet with a decolorable toner which can be decolored when being heated to a temperature higher than a predetermined temperature, is known. In such a case, it is necessary to decolor the image formed on the sheet to be reused before forming a new image thereon. There is a case that such necessity for performing the decoloring process prior to each image formation process may cause inconvenience.

### DESCRIPTION OF THE DRAWINGS

FIG. 1 is a schematic view of an image forming apparatus according to an embodiment;

FIG. 2 is a diagram illustrating components of an image forming section according to the embodiment;

FIG. 3 is a diagram illustrating components of a fixing section according to the embodiment;

FIG. 4 is a schematic block diagram of functional component relating to control of the image forming apparatus according to the embodiment;

FIG. 5 is a diagram illustrating a specific example of a setting information table of the image forming apparatus according to the embodiment;

FIG. 6 is a table illustrating specific examples of a fixing temperature and a decoloring temperature of a decolorable toner according to the embodiment;

FIG. 7 is a diagram illustrating a specific example of a mark according to the embodiment;

FIG. 8 is a diagram illustrating the relationship among a temperature of the fixing section, the number of times of an image forming processing on a sheet, the decolorable toner used for image formation on the sheet and a mark formed on the sheet; and

FIG. 9 is a view illustrating a sheet that is reused by the image forming apparatus according to the embodiment;

FIGS. 10 and 11 depict a flowchart illustrating the flow of a processing of reusing a sheet on which an image is formed with the decolorable toner, in the image forming apparatus according to the embodiment.

### DETAILED DESCRIPTION

In accordance with an embodiment, an image forming apparatus comprises a reading section configured to read a first image on a sheet, an image forming section configured to form a second image on the sheet, a fixing section configured to heat the sheet to fix the second image on the sheet, and a processor. The processor is configured to determine a color of the read first image, select a decolorable toner based on the determined color, and set a target temperature of the fixing section to a temperature that is below a decoloring temperature of the decolorable toner, and above both a decoloring temperature of a decolorable toner having the determined color and a fixing temperature for the decolorable toner.

Hereinafter, an image forming apparatus and an image forming method of an embodiment are described with reference to the accompanying drawings. For the sake of simplicity, the explanation is made on the assumption that a base color of a sheet is white, but it should be understood that the base color of the sheet may not necessarily be white.

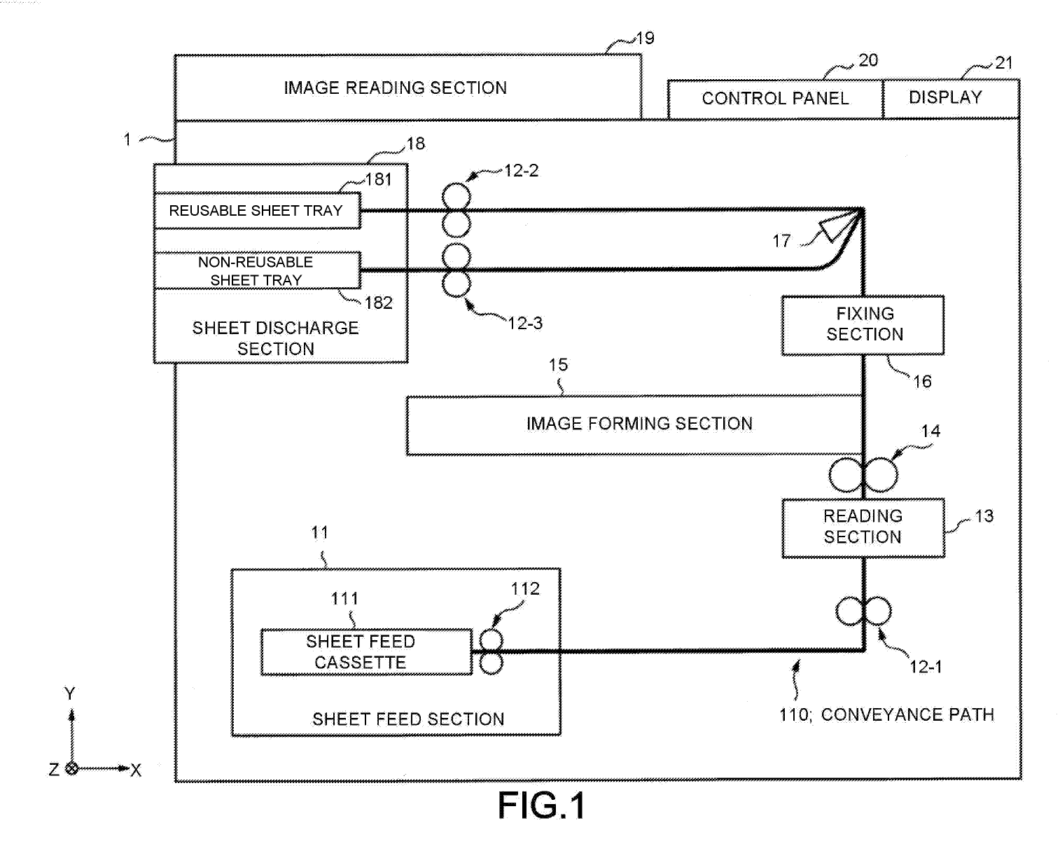

FIG. 1 is a schematic view of an image forming apparatus 1 according to the present embodiment. The image forming apparatus 1 comprises a sheet feed section 11, a conveyance rollers 12-1, 12-2 and 12-3, a reading section 13, a registration roller 14, an image forming section 15, a fixing section 16, a path change section 17, a sheet discharge section 18, an image reading section 19, a control panel 20 and a display 21. The sheet is conveyed along a conveyance path 110 in FIG. 1 from the sheet feed section 11 to the sheet discharge section 18. The sheet is subjected to the image formation processing by the image forming apparatus, and may be, for example, an envelope, a paper having an IC chip, a sheet for an overhead projector, a specially processed sheet (laminated sheet paper, water resistant paper), or the like.

The sheet feed section 11 feeds a sheet to the conveyance path 110. Specifically, the sheet feed section 11 includes a sheet feed cassette 111 and a pickup roller 112. The sheet feed cassette 111 accommodates the sheet. The pickup roller 112 picks up the uppermost sheet one by one from a plurality of sheets accommodated in the sheet feed cassette 111 and sends the sheet to the conveyance path 110 of the image forming apparatus 1. A plurality of the sheet feed cassettes 111 may be provided. If there is a plurality of the sheet feed cassettes 111, one pickup roller 112 is provided for each cassette.

The conveyance rollers 12-1 to 12-3 convey the sheet along the conveyance path 110. The conveyance roller 12-1 conveys the sheet supplied by the pickup roller 112 to the reading section 13. The conveyance roller 12-2 conveys the sheet from the fixing section 16 to a reusable sheet tray 181. The conveyance roller 12-3 conveys the sheet from the fixing section 16 to a non-reusable sheet tray 182.

The reading section 13 includes an image sensor such as a CCD (Charge Coupled Device) or a COMS (Complementary Metal Oxide Semiconductor) sensor. The reading section 13 is positioned at the upstream side in a sheet conveyance direction of the registration roller 14. The reading section 13 is configured to read an image on the sheet which is being conveyed or placed on predetermined position in the image reading section 19. The reading section 13 generates image information indicating the image read from the sheet.

The registration roller 14 causes the sheet to stand by until the temperature of a nip part of the fixing section 16 reaches a predetermined temperature and sends out the sheet to the conveyance path when the temperature of a nip part reaches the predetermined temperature. Hereinafter, the temperature of the nip part of the fixing section 16 is referred to as a temperature of the fixing section 16.

The image forming section 15 forms a toner image indicated by the image information on the sheet based on the image information of an image subjected to the image formation. For example, the image information may be generated by the image reading section 19 or received from other communication devices via a communication section 24 described later. The image forming section 15 forms an image using decolorable toner for yellow (Y), decolorable toner for magenta (M), decolorable toner for cyan (C), and decolorable toner for black (K). The decolorable toner is decolored at a decoloring temperature thereof. Hereinafter, a temperature at which the toner is fixed on the sheet is referred to as a fixing temperature, and a temperature at which the toner is decolored is referred to as the decoloring temperature. The decoloring temperature is generally higher than the fixing temperature.

The fixing section 16 fixes the toner image formed on the sheet by the image forming section 15 on the sheet. The fixing section 16 fixes the toner image on the sheet by heating the sheet to the fixing temperature and decolors the toner image formed with the decolorable toner and fixed on the sheet by heating the sheet to the decoloring temperature.

The path change section 17 is a sheet guiding section, such as a flapper, for switching a conveyance path of the sheet passing through the fixing section 16. Specifically, the conveyance path is switched by the path change section 17 so that the sheet is conveyed to the reusable sheet tray 181 or the non-reusable sheet tray 182.

The sheet discharge section 18 includes the reusable sheet tray 181 and the non-reusable sheet tray 182. The reusable sheet tray 181 is configured to stack a sheet that is reusable (hereinafter, referred to as a “reusable sheet”) thereon. The non-reusable sheet tray 182 configured to stack a sheet that is not reusable (hereinafter, referred to as a “non-reusable sheet”) thereon. The reusable sheet means a sheet on which an image can be formed or decolored, and the non-reusable sheet means a sheet on which formation of an image is determined to be impossible or a sheet of which decoloring is determined to be impossible due to occurrence of a residual image even after decoloring.

The image reading section 19 includes an image sensor such as a CCD or a COMS sensor. The image reading section 19 reads an image of a document which is subjected to the image reading processing as the intensity of light. The image reading section 19 stores the read image information in an auxiliary storage device 23 described later, for example.

The control panel 20 has a plurality of buttons. The control panel 20 receives an operation input by a user. The control panel 20 outputs a signal in response to the operation input performed by the user to a controller (not shown) of the image forming apparatus 1.

The display 21 is a liquid crystal display, an organic EL (Electro Luminescence) display, or the like. The display 21 displays various information on the image forming apparatus 1. The control panel 20 and the display 21 may be integrally formed by using a touch panel or the like.

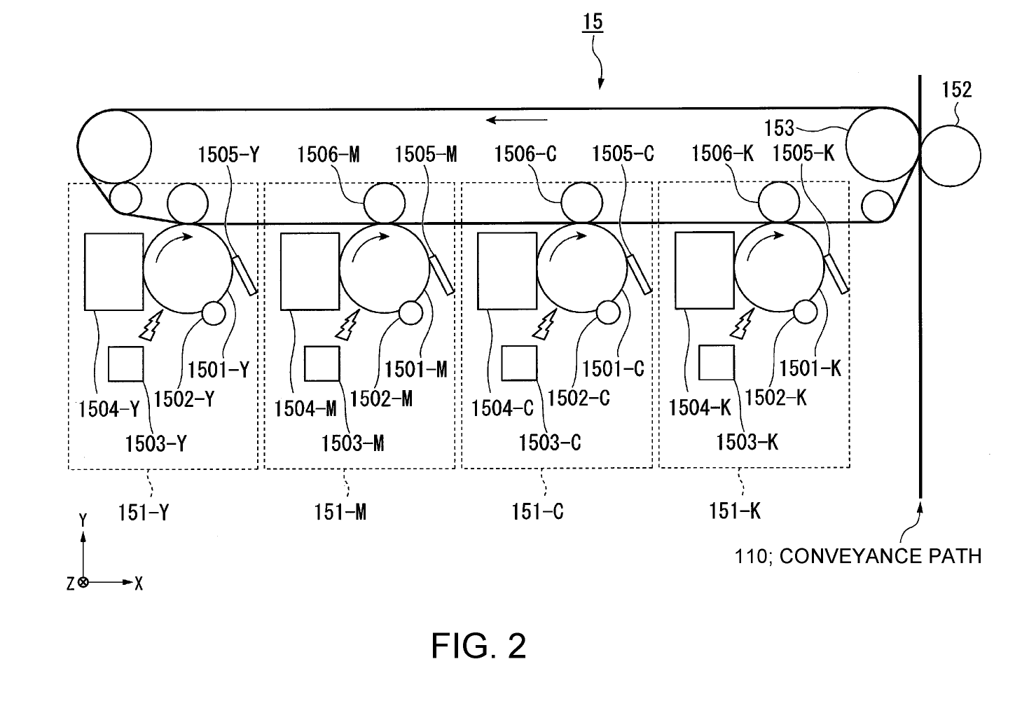

FIG. 2 is a diagram illustrating components of the image forming section 15. The image forming section 15 includes a process unit 151 for each color (i.e., 151-Y, 151-M, 151-C and 151-K), a secondary transfer roller 152, and a secondary transfer counter roller 153. In FIG. 2, the functional sections respectively corresponding to yellow, magenta, cyan and black are distinguished by Y, M, C and K, respectively. For example, 151-Y indicates the process unit 151 for yellow.

The process unit 151 forms a toner image on an intermediate transfer belt 154 which is an endless belt. The process unit 151 includes a photoconductive drum 1501, a charging device 1502, an exposure device 1503, a developing device 1504, a photoconductor cleaner 1505, and a primary transfer roller 1506. In FIG. 2, similar to the process unit 151, the functional sections respectively corresponding to yellow, magenta, cyan and black are distinguished by Y, M, C, and K, respectively. For example, 1501-M indicates the photoconductive drum 1501 for magenta.

The photoconductive drum 1501 temporarily holds an electrostatic latent image on an outer peripheral surface thereof. The photoconductive drum 1501 is an image carrier, and is for example, a cylindrical drum. The photoconductive drum 1501 has a photoconductor substance on its outer peripheral surface and has a property of releasing static electricity only at a portion irradiated with light. The charging device 1502 uniformly charges the surface of the photoconductive drum 1501 with static electricity. The charging device 1502 is, for example, a needle electrode. The exposure device 1503 forms an electrostatic latent image of an image, which is subjected to the image formation processing, on the outer peripheral surface of the photoconductive drum 1501. The exposure device 1503 is, for example, a laser irradiation device. The developing device 1504 supplies the toner to the outer peripheral surface of the photoconductive drum 1501 and develops the electrostatic latent image with the supplied toner. The photoconductor cleaner 1505 removes the residual toner on the outer peripheral surface of the photoconductive drum 1501. The primary transfer roller 1506 transfers the toner image developed on the outer peripheral surface of the photoconductive drum 1501 onto the intermediate transfer belt 154.

The secondary transfer roller 152 transfers the toner image on the intermediate transfer belt 154 onto the sheet. The secondary transfer counter roller 153 is positioned to face the secondary transfer roller 152 across the intermediate transfer belt 154 and sandwiches the sheet between the secondary transfer roller 152 and the intermediate transfer belt 154 to convey the sheet onto which the image is transferred.

The image forming section 15 may include a toner cartridge for a non-decolorable toner. The image forming section 15 may form an image using the non-decolorable toner as well as forming an image with the decolorable toner.

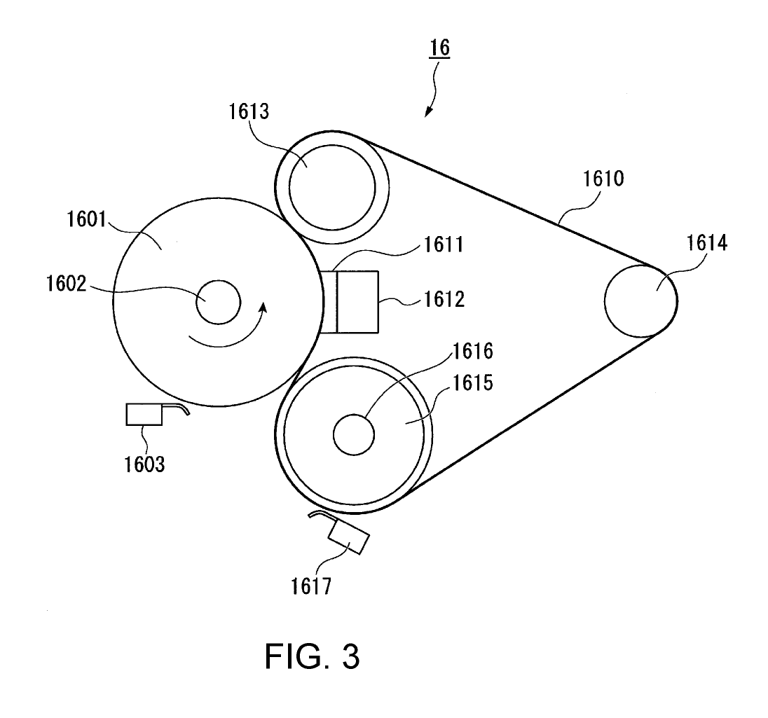

FIG. 3 is a diagram illustrating components of the fixing section 16. The fixing section 16 includes a heat roller 1601, a HR lamp 1602, a HR thermistor 1603, a pressure belt 1610, a pressure pad 1611, a pad holder 1612, a pressure roller 1613, a tension roller 1614, a belt heat roller 1615, a pressure belt lamp 1616 and a pressure thermistor 1617.

The heat roller 1601 heats the sheet for fixing or decoloring the toner image on the sheet. For example, the heat roller 1601 is formed in a cylindrical shape. For example, the heat roller 1601 includes the HR lamp 1602 therein. The heat roller 1601 heats the sheet by being heated by the heat generated by the HR lamp 1602.

The HR thermistor 1603 measures the surface temperature of the heat roller 1601. The surface temperature of the heat roller 1601 measured by the HR thermistor 1603 is substantially the same as the temperature of a fixing nip part described later. Therefore, in the present embodiment, the temperature of the fixing section 16 is measured by the HR thermistor 1603. However, the temperature of the fixing section 16 may be acquired by any measurement method as long as it is the temperature for reflecting the temperature of the nip part.

The pressure belt 1610 is held by the pressure roller 1613, the tension roller 1614, and the belt heat roller 1615. The pressure belt 1610 is in the pressure contact with the heat roller 1601 by the pressure pad 1611, the pressure roller 1613 and the belt heat roller 1615. By the pressure contact, a fixing nip part is formed between the pressure belt 1610 and the heat roller 1601.

The pressure pad 1611 is in pressure contact with the heat roller 1601 across the pressure belt 1610. The pad holder 1612 enables the pressure pad 1611 to be in the pressure contact with an inner peripheral surface of the pressure belt 1610 to press the pressure belt 1610 toward the heat roller 1601. The pressure roller 1613 also enables the pressure belt 1610 to be in the pressure contact with the heat roller 1601.

The tension roller 1614 is arranged at a position away from the pressure roller 1613 and the belt heat roller 1615 and applies tension to the pressure belt 1610.

The pressure belt lamp 1616 is provided inside the belt heat roller 1615. The pressure belt lamp 1616 heats the belt heat roller 1615 by generating the heat. The pressure belt lamp 1616 includes a halogen lamp, for example.

The pressure thermistor 1617 measures the surface temperature of the pressure belt 1610. The surface temperature is the temperature of the vicinity of the belt roller.

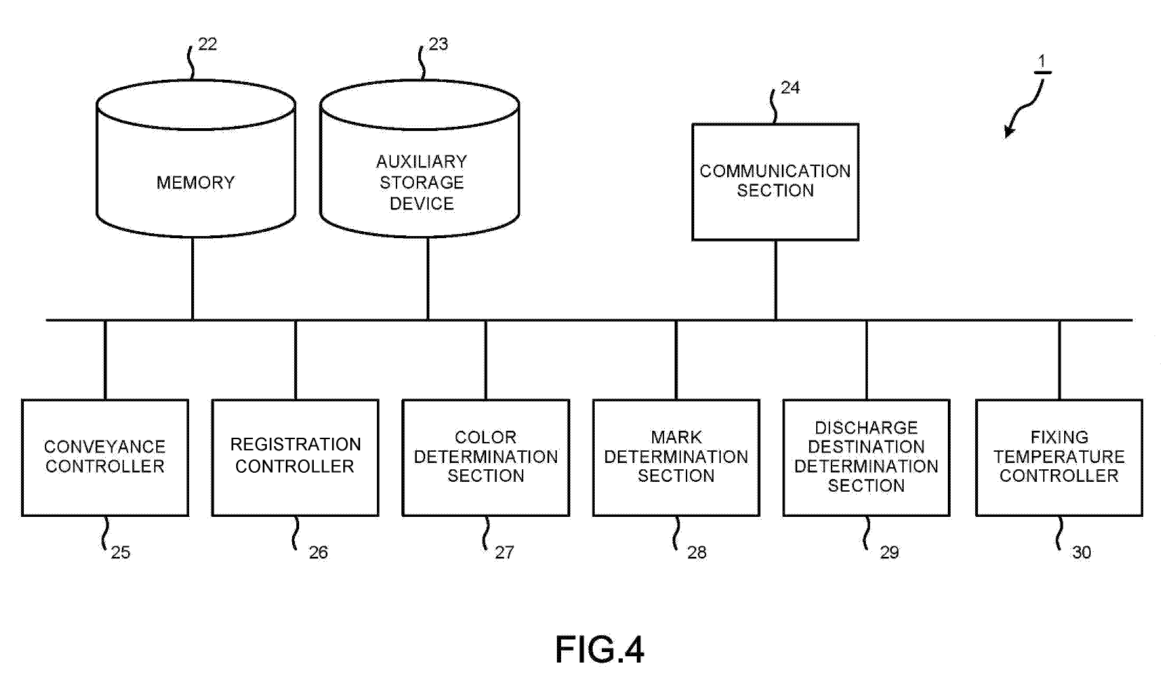

FIG. 4 is a schematic block diagram of the functional component relating to the control of the image forming apparatus 1. The image forming apparatus 1 is provided with a CPU (Central Processing Unit), a memory 22 and an auxiliary storage device 23 connected via a bus, and executes a program to function as the communication section 24, a conveyance controller 25, a registration controller 26, a color determination section 27, a mark determination section 28, a discharge destination determination section 29 and a fixing temperature controller 30. All or part of these components of the image forming apparatus 1 may be realized in hardware such as an ASIC (Application Specific Integrated Circuit), a PLD (Programmable Logic Device) or a FPGA (Field Programmable Gate Array). The program may be recorded in a computer-readable recording medium. The computer-readable recording medium is, for example, a portable medium such as a flexible disk, a magneto-optical disk, a ROM, a CD-ROM or the like, or a storage device such as a hard disk built in a computer system. The program may be transmitted via an electric communication line.

The memory 22 temporarily stores data used by each functional section. The memory 22 is, for example, a semiconductor memory.

The auxiliary storage device 23 stores the image information generated by the reading section 13, image information of an image read by the image reading section 19, and image information input from another information processing apparatus. The auxiliary storage device 23 includes, for example, a hard disk or a SSD (Solid State Drive). The image information stored in the auxiliary storage device 23 may be transmitted to another information processing apparatus via a network. The auxiliary storage device 23 stores a setting information table D101. The setting information table D101 is information on fixing and decoloring of the image forming apparatus 1.

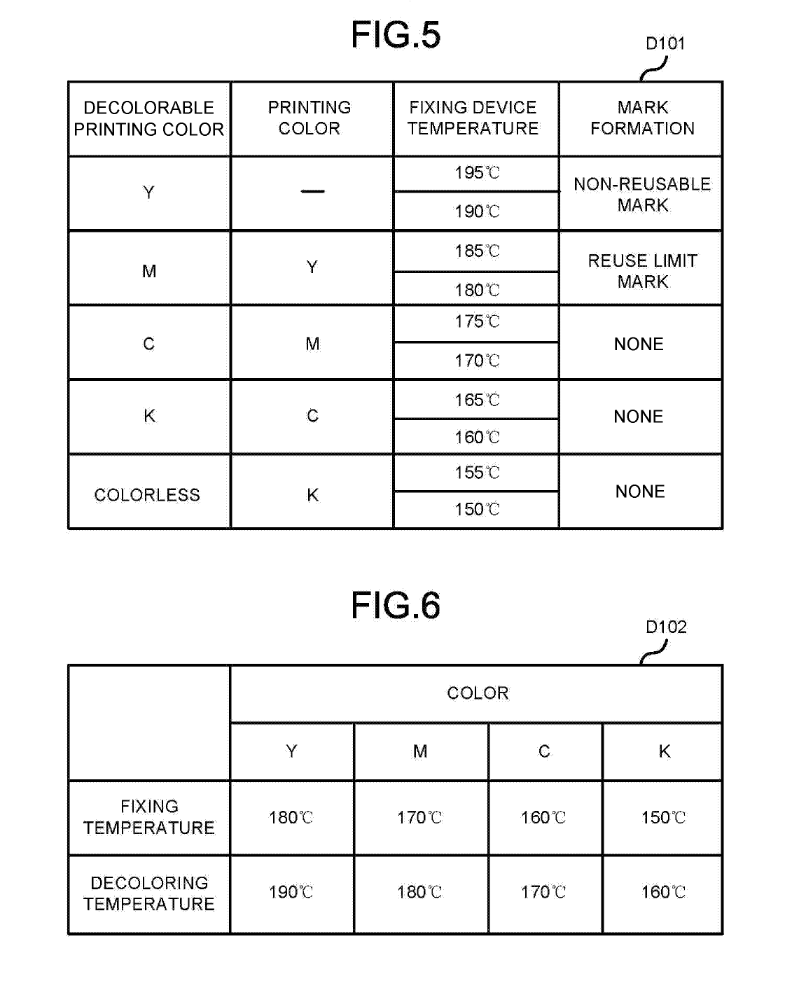

FIG. 5 is a diagram illustrating a specific example of the setting information table D101 of the image forming apparatus 1. The setting information table D101 has a record for each “decolorable printing color.” Each record has values of “decolorable printing color”, “printing color”, “fixing device temperature”, “mark formation.” The “decolorable printing color” represents a color to be decolored. The “decolorable printing color” has values indicating ‘Y’, ‘M’, ‘C’, ‘K’ and ‘colorless’. ‘Y’, ‘M’, ‘C’ and ‘K’ indicate that the color of the image read by the reading section 13 is yellow, magenta, cyan and black, respectively. The ‘colorless’ indicates that there is no image on a sheet to be read by the reading section 13. The “printing color” has values of ‘Y’, ‘M’, ‘C’ and ‘K’. ‘Y’, ‘M’, ‘C’ and ‘K’ indicate that images are to be formed with the yellow toner, the magenta toner, the cyan toner, and the black toner, respectively. The “fixing device temperature” indicates a temperature range. In FIG. 5, the temperature range is indicated by two temperatures, a lowest temperature and a highest temperature. Depending on each record of the “decolorable printing color”, the fixing section 16 is heated to a temperature within a range indicated by the two temperatures. Of the temperatures indicated by the two values, the lower temperature is the decoloring temperature of the toner of the color indicated by the corresponding “decolorable printing color”, and the higher temperature is a temperature at which the toner of the color indicated by the corresponding “printing color” is not decolored. The “mark formation” is information (hereinafter, referred to as “mark forming condition”) indicating whether to form a non-reusable mark or a reuse limit mark at the time of fixing or decoloring the toner at a temperature within the temperature range indicated by the value of the fixing device temperature. The ‘non-reusable mark formation’ indicates formation of the non-reusable mark on the sheet. The non-reusable mark indicates that the sheet is not reusable since the number of times of image formation or decoloring exceeds a predetermined number of times. The ‘reuse limit mark formation’ indicates formation of the reuse limit mark on the sheet. The reuse limit mark indicates that a decoloring processing of an image on the sheet is enabled only once. The temperature within the temperature range indicated by the “fixing device temperature” is a specific example of the image forming temperature.

Returning to FIG. 4, the communication section 24 includes a communication interface. The communication interface communicates with the other communication devices.

The conveyance controller 25 controls the path change section 17 and operation conditions of the rollers, such as a rotation speed and a rotation direction of the conveyance rollers 12-1 to 12-3.

The registration controller 26 controls the operation conditions of the roller, such as a rotation speed and a rotation direction of the registration roller 14.

The color determination section 27 determines which of the colors previously stored in the auxiliary storage device 23 the color of the image read by the reading section 13 is. The mark determination section 28 executes a processing to determine whether or not a mark exists. If the mark exists, it is determined which one of the marks previously stored in the auxiliary storage device 23 the detected mark is. The discharge destination determination section 29 determines a sheet discharge destination based on the determination result of the color determination section 27 or the mark determination section 28. The mark determination section 28 is a specific example of the image formation determination section.

The fixing temperature controller 30 refers to each record in the setting information table D101 to control the fixing section 16 in such a manner that the temperature of the fixing section 16 is the temperature within the temperature range indicated by the record referred to. For example, if the color of the image read by the reading section 13 is magenta (M), the fixing temperature controller 30 refers to the record in which the decolorable printing color is M in the setting information table D101 to control the fixing section 16 in such a manner that a new image is formed with yellow (Y) decolorable toner and the temperature of the fixing section 16 is a temperature in a range of 180 degrees centigrade to 185 degrees centigrade.

FIG. 6 is a table illustrating specific examples of the fixing temperature and the decoloring temperature of the decolorable toner. For example, the fixing temperature of the yellow (Y) decolorable toner is 180 degrees centigrade. The decoloring temperature of yellow decolorable toner is 190 degrees centigrade. Therefore, the yellow decolorable toner is fixed on the sheet by being heated at a temperature equal to or higher than 180 degrees centigrade and lower than 190 degrees centigrade, and is decolored by being heated at a temperature of 190 degrees centigrade or higher.

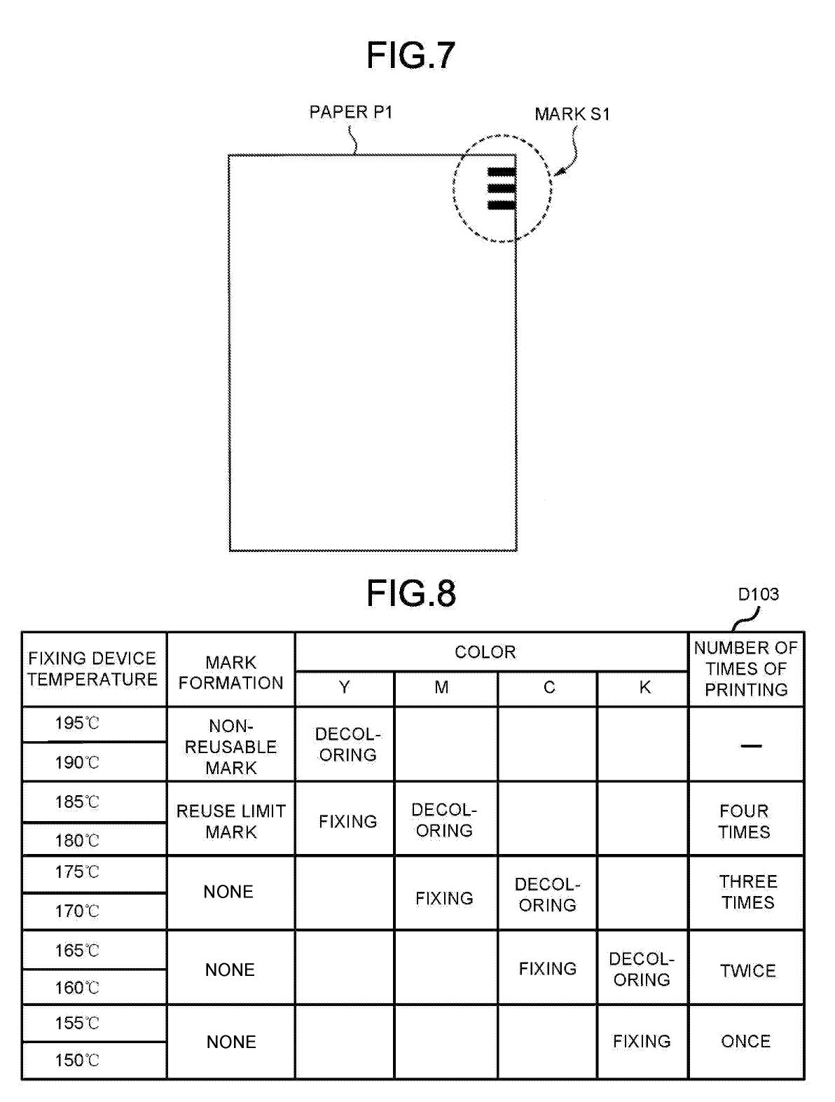

FIG. 7 shows a specific example of a mark S1. The mark S1 is a non-reusable mark, and is formed as three lines with equal length at an end of sheet P1, as shown in FIG. 7. As long as the image forming apparatus 1 can determine that the mark S1 indicates a mark forming condition, the mark S1 can be any image formed with any toner. The mark S1 may indicate a difference in conditions under which the image forming processing is executed with different colors. The mark S1 may be formed anywhere on the sheet P1 as long as it is formed at a position where the image forming apparatus 1 can determine that the mark S1 indicates the condition under which the image forming processing is carried out.

FIG. 8 is a diagram illustrating the relationship among the temperature of the fixing section 16, the number of times of the image forming processing on a sheet, the decolorable toner used for image formation on the sheet and the mark formed on the sheet. A table D103 shows a specific example of the image forming processing determined by “number of times of printing.” The values of the “fixing device temperature”, the “mark formation” and the “color” shown in the table D103 are the same as those in FIG. 5 and FIG. 6. For example, if the temperature of the fixing section 16 is set to 170 degrees centigrade to 175 degrees centigrade, the image formed with the cyan (C) decolorable toner is decolored and a new image is formed by fixing the magenta (M) decolorable toner. The “number of times of printing” indicates how many times the image forming apparatus 1 executes the image formation with which decolorable toner at the time the image forming apparatus 1 executes the image forming processing on one sheet plural times. For example, the record in which the number of times of printing is three indicates the condition of the image formation at the time of the third image formation, and indicates that the color read by the reading section 13 is cyan (C), and that the image is formed with the magenta (M) decolorable toner. The color of the image read in the reading section 13 is the color of the decolorable toner used in the preceding image forming processing and cyan (C) is the color of the decolorable toner used in the image formation in the second image forming processing.

The symbol “-” in the number of times of printing in the table D103 indicates that the image forming apparatus 1 only executes the decoloring of the image without forming the image. For example, if the image forming apparatus 1 tries to execute the image formation again on the sheet on which a fourth image formation is executed, the image forming apparatus 1 only executes the decoloring. In other words, the image forming apparatus 1 decolors the toner whose decoloring temperature is lower than 190 degrees centigrade and does not forma new image. Therefore, an image is not formed on the decolored sheet and the image is colorless. A non-reusable mark is formed on the sheet. If the sheet is colorless, it cannot be distinguished whether the sheet is a new sheet or a sheet of which the number of times of printing exceeds a limit. Therefore, depending on the presence or absence of the mark printed on the sheet, the image forming apparatus 1 determines whether or not a new image can be formed.

In the third image forming processing, no mark is formed on the sheet, but in the fourth image forming processing, the reuse limit mark is formed on the sheet. In the fifth image forming processing, the non-reusable mark is formed on the sheet.

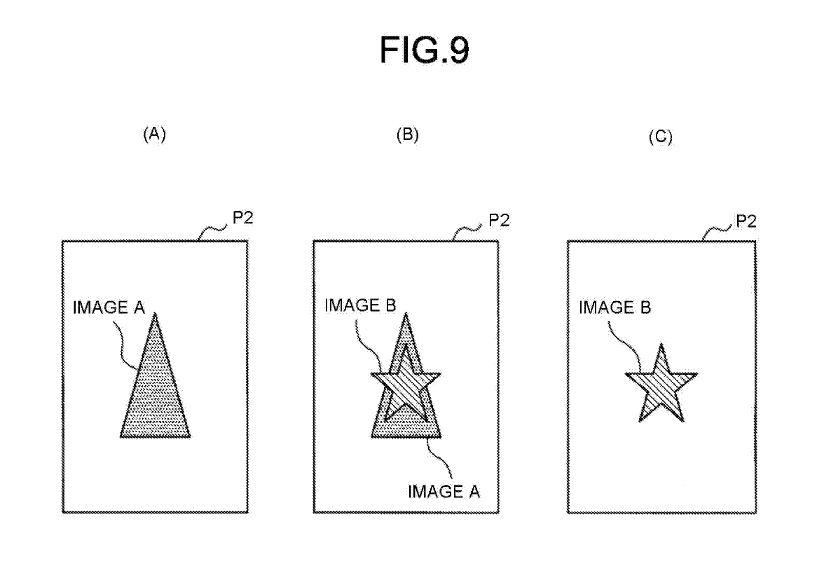

FIG. 9 is a view illustrating that the sheet is reused by the image forming apparatus 1 according to the present embodiment. Section (A) of FIG. 9 shows that an image A indicated by a painted triangle is formed on the surface of a sheet P2. Section (B) of FIG. 9 shows a state in which the toner image of a star-shaped image B indicated by a diagonal line is formed on the sheet P2. The fixing temperature of the decolorable toner forming the image B is higher than the decoloring temperature of decolorable toner forming the image A. Section (C) of FIG. 9 shows a state in which the sheet P2 in FIG. 9(B) is heated, the image A is decolored, and the image B is fixed. As described above, the temperature at which the image B is fixed is higher than the decoloring temperature of the decolorable toner forming the image A. Therefore, when the image B is fixed on the sheet P2, the image A is decolored and only the image B is formed on the sheet P2.

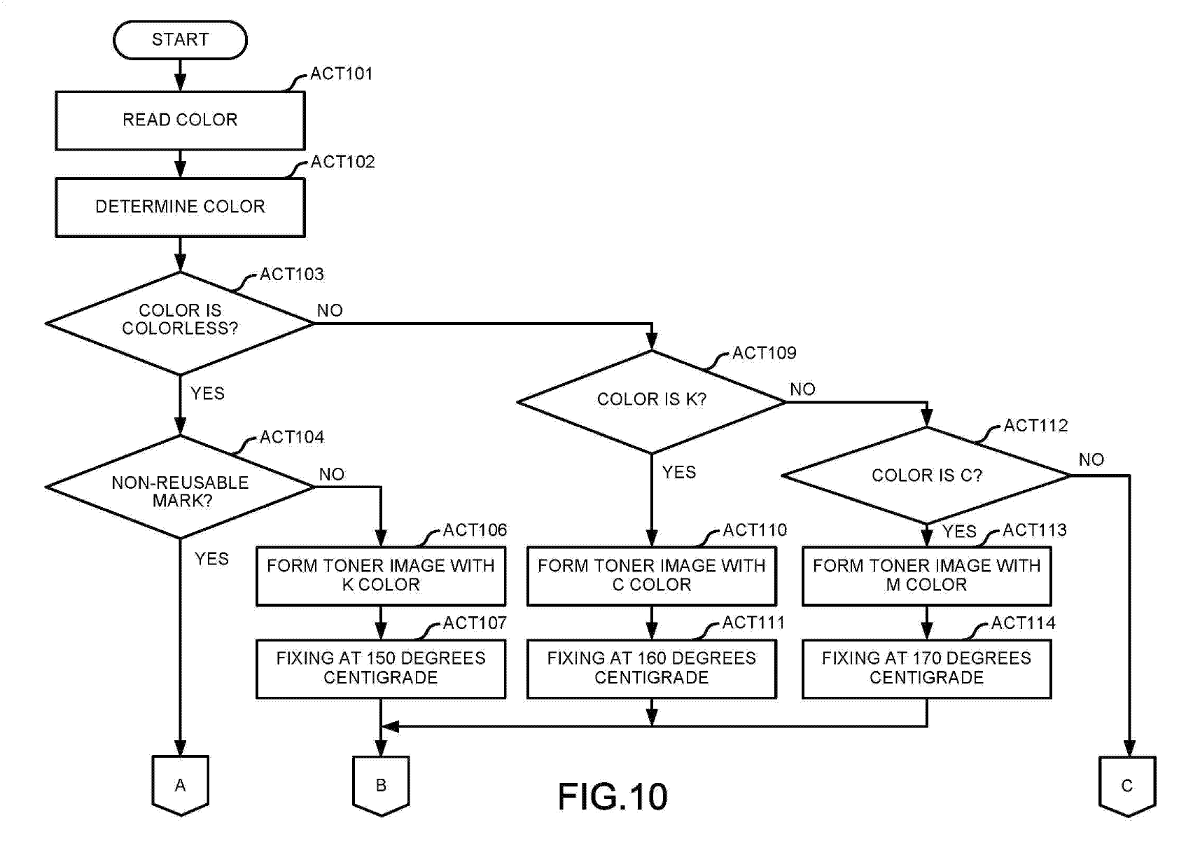

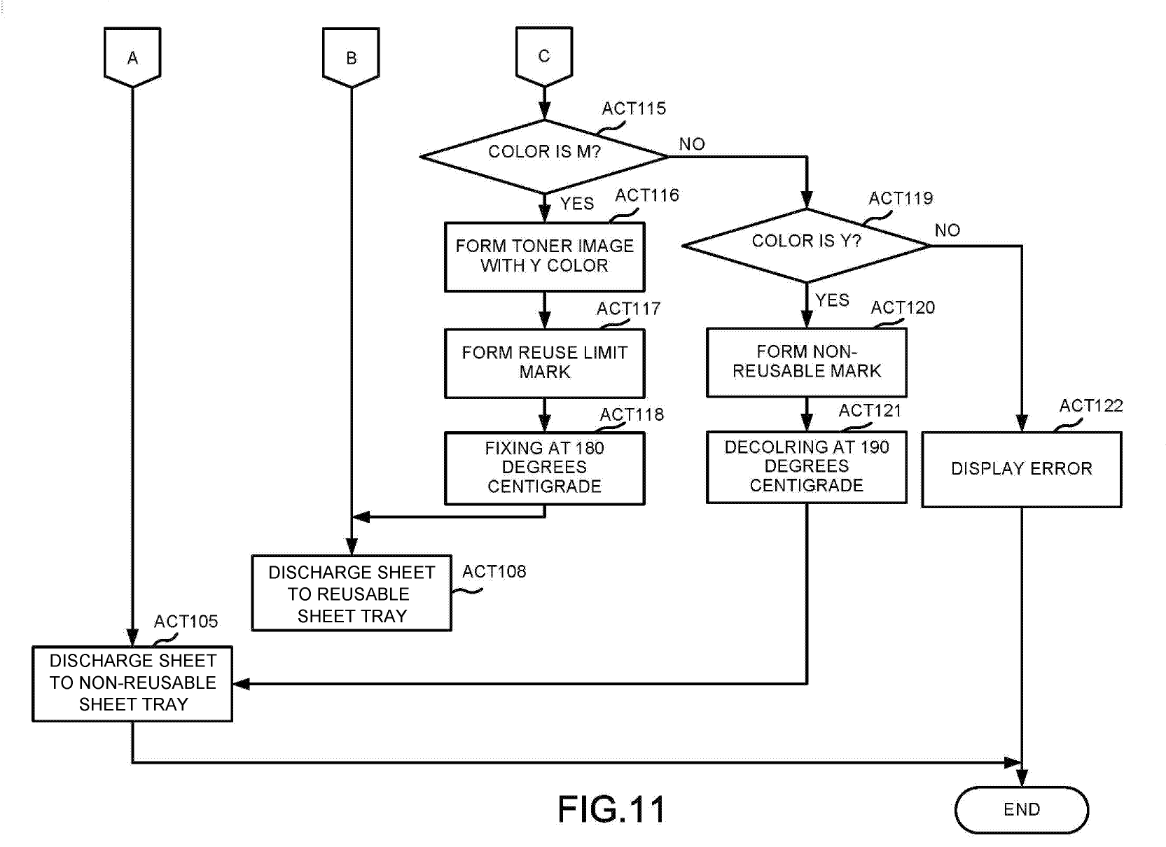

FIG. 10 and FIG. 11 are flowcharts illustrating the flow of a processing of reusing the sheet on which the image forming apparatus 1 forms an image with the decolorable toner. The reading section 13 reads an image formed by the decolorable toner on a sheet fed by the sheet feed section 11 (ACT 101). The color determination section 27 determines the color of the image read in ACT 101 (ACT 102). The color determination section 27 determines whether or not the color of the image read in ACT 101 is colorless (ACT 103). In the determination in ACT 103, if it is determined that the color of the read image is colorless, the mark determination section 28 determines whether or not there is a mark on the image read by the reading section 13 (ACT 104). If the mark determination section 28 determines that there is the mark on the image read by the reading section 13 (Yes in ACT 104), the mark is the non-reusable mark as shown in the table D103 in FIG. 8. Therefore, the discharge destination determination section 29 determines to discharge the sheet to the non-reusable sheet tray 182. Based on the determination result of the discharge destination determination section 29, the conveyance controller 25 controls the path change section 17 so as to convey the sheet to the non-reusable sheet tray 182. Under the control of the conveyance controller 25, the sheet is conveyed to the non-reusable sheet tray 182 (ACT 105).

If the mark is not detected in ACT 104 (No in ACT 104), the fixing temperature controller 30 refers to the record in which the value of the “decolorable printing color” in the setting information table D101 is ‘colorless’. The fixing temperature controller 30 controls the registration roller 14 via the registration controller 26 so as not to convey the sheet to the fixing section 16 until the temperature of the fixing section reaches the temperature (for example, 153 degrees centigrade) within the temperature range indicated by the value of “fixing device temperature.” It is assumed that the heating of the fixing section 16 is started in ACT 104. After the temperature of the fixing section 16 reaches the temperature within the temperature range indicated by the value of “fixing device temperature”, the image forming section 15 forms a new toner image on the sheet (ACT 106). The new toner image is formed with the black (K) decolorable toner indicated by the value of “printing color” of the record in which the value of “decolorable printing color” is ‘colorless’ in the setting information table D101. The formed toner image is fixed on the sheet by the fixing section 16 (ACT 107). Since the color of the decolorable toner forming the image is black (K), the discharge destination determination section 29 determines that the sheet is reusable, and determines that the discharge destination of the sheet on which the image is formed with the black (K) decolorable toner is the reusable sheet tray 181. The sheet is conveyed to the reusable sheet tray 181 (ACT 108).

On the other hand, in ACT 103, if it is determined that the color of the image read by the reading section 13 is not colorless (No in ACT 103), the color determination section 27 determines whether or not the color of the image read by the reading section 13 is black (K) (ACT 109). If the color of the image read by the reading section 13 is black (K) (Yes in ACT 109), the fixing temperature controller 30 refers to the record in which the value of the “decolorable printing color” is ‘K’ in the setting information table D101. The fixing temperature controller 30 controls the registration roller 14 via the registration controller 26 so as not to convey the sheet to the fixing section 16 until the temperature of the fixing section 16 reaches a temperature (e.g., 163 degrees centigrade) within the temperature range indicated by the value of the “fixing device temperature.” It is assumed that the heating of the fixing section 16 is started, for example, in ACT 109. After the temperature of the fixing section 16 reaches the temperature within the temperature range indicated by the value of the “fixing device temperature”, the image forming section 15 forms a new toner image on the sheet (ACT 110). The new toner image is formed with the cyan (C) decolorable toner indicated by the value of the “printing color” corresponding to the record in which the value of the “decolorable printing color” is “K” in the setting information table D101. Thereafter, the sheet is conveyed to the fixing section 16 heated to 160 degrees centigrade to 165 degrees centigrade. Thereafter, the cyan (C) toner image formed on the sheet is fixed by the fixing section 16 (ACT 111). On the other hand, the black (K) image previously formed on the sheet is decolored. Since the color of the decolorable toner forming the image is cyan (C), the discharge destination determination section 29 determines that the sheet is reusable, and determines that the sheet discharge destination is the reusable sheet tray 181. The sheet is conveyed to the reusable sheet tray 181 (ACT 108).

On the other hand, in ACT 109, if it is determined that the color of the image read by the reading section 13 is not black (K) (No in ACT 109), the color determination section 27 determines whether or not the color is cyan (C) (ACT 112). If the color is cyan (C) (Yes in ACT 112), the fixing temperature controller 30 refers to the record in which the value of the “decolorable printing color” is ‘C’ in the setting information table D101. The fixing temperature controller 30 controls the registration roller 14 via the registration controller 26 so as not to convey the sheet until the temperature of the fixing section 16 reaches a temperature (e.g., 173 degrees centigrade) within the temperature range indicated by the value of the “fixing device temperature.” It is assumed that the heating of the fixing section 16 is started, for example, in ACT 112. After the temperature of the fixing section 16 reaches the temperature within the temperature range indicated by the value of the “fixing device temperature”, the image forming section 15 forms a new toner image on the sheet (ACT 113). The new toner image is formed with the magenta (M) decolorable toner indicated by the value of the “printing color” corresponding to the record in which the value of the “decolorable printing color” is “C” in the setting information table D101. Thereafter, the sheet is conveyed to the fixing section 16 heated to 170 degrees centigrade to 175 degrees centigrade. The magenta (M) toner image formed on the sheet is fixed by the fixing section 16 (ACT 114). On the other hand, the cyan (C) image previously formed on the sheet is decolored. Since the color of the decolorable toner forming the image is magenta (M), the discharge destination determination section 29 determines that the sheet is reusable, and determines that the sheet discharge destination is the reusable sheet tray 181. The sheet is conveyed to the reusable sheet tray 181 (ACT 108).

On the other hand, if it is determined in ACT 112 that the color of the image read by the reading section 13 is not cyan (C) (No in ACT 112), the color determination section 27 determines whether or not the color is magenta (M) (ACT 115). If the color is magenta (M) (Yes in ACT 115), the fixing temperature controller 30 refers to the record in which the value of the “decolorable printing color” is ‘M’ in the setting information table D101. The fixing temperature controller 30 controls the registration roller 14 via the registration controller 26 so as not to convey the sheet until the temperature of the fixing section 16 reaches a temperature (e.g., 183 degrees centigrade) within the temperature range indicated by the value of the “fixing device temperature.” It is assumed that the heating of the fixing section 16 is started, for example, in ACT 115. After the temperature of the fixing section 16 reaches the temperature within the temperature range indicated by the value of the “fixing device temperature”, the image forming section 15 forms a new toner image on the sheet (ACT 116). The new toner image is formed with the yellow (Y) decolorable toner indicated by the value of the “printing color” corresponding to the record in which the value of the “decolorable printing color” is “M” in the setting information table D101. Furthermore, the fixing temperature controller 30 controls the image forming section 15 to form the reuse limit mark by the non-decolorable toner on the sheet according to the value of the “mark formation” in the record in which the value of the “decolorable printing color” is “M.” Thereafter, the sheet is conveyed to the fixing section 16 heated to 180 degrees centigrade to 185 degrees centigrade. The yellow (Y) toner image and the reuse limit mark formed on the sheet are fixed by the fixing section 16, and the image and the reuse limit mark are formed on the sheet (ACT 118). On the other hand, the magenta (M) image previously formed on the sheet is decolored. Since the color of the decolorable toner forming the image is yellow (Y), the discharge destination determination section 29 determines that the sheet is reusable, and determines that the sheet discharge destination is the reusable sheet tray 181. The sheet is conveyed to the reusable sheet tray 181 (ACT 108).

On the other hand, in ACT 115, if it is determined that the color of the image read by the reading section 13 is not magenta (M) (No in ACT 115), the color determination section 27 determines whether or not the color is yellow (Y) (ACT 119). If the color is yellow (Y) (Yes in ACT 119), the fixing temperature controller 30 refers to the record in which the value of the “decolorable printing color” is ‘M’ in the setting information table D101. The fixing temperature controller 30 controls the registration roller 14 via the registration controller 26 so as not to convey the sheet until the temperature of the fixing section 16 reaches a temperature (e.g., 193 degrees centigrade) within the temperature range indicated by the value of the “fixing device temperature.” It is assumed that the heating of the fixing section 16 is started, for example, in ACT 119. After the temperature of the fixing section 16 reaches the temperature within the temperature range indicated by the value of the “fixing device temperature”, the fixing temperature controller 30 controls the image forming section 15 to form the non-reusable mark by the non-decolorable toner on the sheet according to the value of the “mark formation” included in the record in which the value of the “decolorable printing color” is ‘Y’ (ACT 120). Thereafter, the sheet is conveyed to the fixing section 16 heated to 190 degrees centigrade to 195 degrees centigrade. The non-reusable mark formed on the sheet is fixed by the fixing section 16 and the non-reusable mark is formed on the sheet (ACT 121). On the other hand, the yellow (Y) image previously formed on the sheet is decolored. Since only the decoloring of the image is executed and the new image is not formed on the sheet on which the non-reusable mark is formed, the discharge destination determination section 29 determines that the sheet is not reusable, and determines that the sheet discharge destination is the non-reusable sheet tray 182. The sheet is conveyed to the non-reusable sheet tray 182 (ACT 108).

On the other hand, if it is determined in ACT 115 that the color of the image read by the reading section 13 is not yellow (Y) (No in ACT 119), the image forming apparatus 1 displays an error indicating that the image formation cannot be executed and the decoloring cannot be executed anymore is displayed on the display 21.

### Modification

Incidentally, the image forming apparatus 1 may be provided with a decolorable toner selection section. The decolorable toner selection section refers to a record in which a value indicating the color determined by the color determination section 27 is the value of “decolorable printing color.” The decolorable toner selection section selects the decolorable toner of the color indicated by the value of the “printing color” of the record as the decolorable toner used for forming the image. The decolorable toner selection section informs the image forming section 15 of information indicating the determined decolorable toner.

In the fixing temperature controller 30 of the embodiment, at the time of the control of the fixing section 16, based on the image read by the reading section 13, the fixing section 16 is not necessarily controlled in such a manner that the fixing section 16 is set to the predetermined temperature. The fixing temperature controller 30 may control the fixing section 16 in such a manner that, for example, the fixing section 16 is set to a predetermined temperature based on predetermined information acquired via the control panel 20. The predetermined information acquired by the fixing temperature controller 30 via the control panel 20 may be, for example, information indicating the temperature instructed by the user.

According to the embodiment described above, by using the decolorable toner of which the fixing temperature has the same temperature zone as the decoloring temperature of the decolorable toner forming an image to be decolored from now on to form a new image, it is possible to execute the decoloring processing and the formation of a new image at the same time. Therefore, it is not necessary for the user to perform an operation of decoloring the image with respect to the image forming apparatus every time the image is formed, and it is possible to improve the convenience of the user.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a reading section configured to read a first image on a sheet;
an image forming section configured to form a second image on the sheet;
a fixing section configured to heat the sheet to fix the second image on the sheet; and
a processor configured to determine a color of the read first image, select a decolorable toner based on the determined color, and set a target temperature of the fixing section to a temperature that is below a decoloring temperature of the decolorable toner, and above both a decoloring temperature of a decolorable toner having the determined color and a fixing temperature for the decolorable toner.

2. The image forming apparatus according to claim 1, wherein
the image forming section is configured to form a mark indicating that the sheet is not reusable or that the sheet has reached a reuse limit according to a predetermined condition at the time of forming the second image.

3. The image forming apparatus according to claim 1, further comprising:
the processor is configured to detect a mark based on a reading result of the reading section and determine whether to form the second image based on a result of the detection, wherein
the processor controls the fixing section to heat the sheet to a temperature at which the decolorable toner having the determined color is decolored, if the processor determines that the second image is not to be formed on the sheet.

4. The image forming apparatus according to claim 1, further comprising:
a non-reusable sheet tray; and
a reusable sheet tray,
wherein if the determined color is a first color, the sheet is discharged to the non-reusable sheet tray, and if the determined color is a second color, the sheet is discharged to the reusable sheet tray.

5. The image forming apparatus according to claim 4, wherein if the determined color is a third color, the sheet is discharged to the reusable sheet tray.

6. The image forming apparatus according to claim 5, wherein
if the determined color is the first, second, or third, the fixing section, upon heating the sheet to the target temperature, fixes the second image onto the sheet while also decoloring the first image formed on the sheet.

7. The image forming apparatus according to claim 5, wherein
if the determined color is no color, the fixing section, upon heating the sheet to the target temperature, fixes the second image onto the sheet without decoloring any image.

8. An image forming apparatus, comprising:
a reading section configured to read a first image on a sheet;
an image forming section configured to form a second image on the sheet;
a fixing section configured to apply heat to the sheet; and
a processor configured to determine a color of the first image, and based on the determined color, (i) select a decolorable toner for use by the image forming section, (ii) set a target temperature for the fixing section based on the determined color, and (iii) control the image forming section to form no mark or a particular mark on the sheet in addition to the second image.

9. The image forming apparatus according to claim 8, wherein
the image forming section is configured to form a mark indicating that the sheet is not reusable if the determined color is yellow or that the sheet has reached a reuse limit if the determined color is magenta, and to form no mark if the determined color is cyan or black.

10. The image forming apparatus according to claim 8, further comprising:
the processor is configured to detect a mark based on a reading result of the reading section and determine whether to form the second image based on a result of the detection, wherein
the processor controls the fixing section to heat the sheet to a temperature at which the decolorable toner having the determined color is decolored, if the processor determines that the second image is not to be formed on the sheet.

11. The image forming apparatus according to claim 8, further comprising:
a non-reusable sheet tray; and
a reusable sheet tray,
wherein if the determined color is yellow or magenta, the sheet is discharged to the non-reusable sheet tray, and if the determined color is no color, black or cyan, the sheet is discharged to the reusable sheet tray.

12. The image forming apparatus according to claim 11, wherein
if the determined color is black, cyan, or magenta, the fixing section, upon heating the sheet to the target temperature, fixes the second image onto the sheet while also decoloring the first image formed on the sheet.

13. The image forming apparatus according to claim 11, wherein
if the determined color is no color, the fixing section, upon heating the sheet to the target temperature, fixes the second image onto the sheet without decoloring any image.

14. A method of reusing a sheet on which a first image is formed thereon, comprising:
reading the first image on the sheet;
forming a second image on the sheet with a decolorable toner;
heating the sheet to a target temperature to fix the second image on the sheet while decoloring the first image on the sheet; and
wherein the decolorable toner is selected and the target temperature is set based on a color of the first image.

15. The method according to claim 14, wherein the target temperature is set to a temperature that is below a decoloring temperature of the decolorable toner, and above both a decoloring temperature of a decolorable toner having the color of the first image and a fixing temperature for the decolorable toner.

16. The method according to claim 14, further comprising:
forming a mark indicating that the sheet is not reusable or that the sheet has reached a reuse limit according to a predetermined condition at the time of forming the second image.

17. The method according to claim 14, further comprising:
discharging the sheet to a non-reusable sheet tray if the color of the first image is a first color; and
discharging the sheet to a reusable sheet tray if the color of the first image is a second color or a third color.

18. The method according to claim 17, wherein the first color is magenta, and second and third colors are black and cyan, respectively.
